(19) United States
(12) Patent Application Publication
(10) Pub. No.: US 2026/0104297 A1
(43) Pub. Date: Apr. 16, 2026

(54) Thermochromic Cable Wrap

(71) Applicant: ABB Schweiz AG, Baden (CH)

(72) Inventor: John Lake Lewis, Memphis, TN (US)

(21) Appl. No.: 18/913,182

(22) Filed: Oct. 11, 2024

(51) Int. Cl. G01K 11/12

(52) U.S. Cl. CPC G01K 11/12

(57) ABSTRACT

A thermochromic cable wrap includes a body defining a first surface and an opposite second surface, wherein the first surface defines an opening extending between a first end and an opposite second end. The body includes a thermochromic pigment configured to produce a change in color along at least a portion of the body in response to an increase in the temperature of the associated portion of the body.

### FIELD OF THE DISCLOSURE

The field of disclosure relates generally to cable wraps, and more particularly, to thermochromic cable wraps.

### BACKGROUND OF THE DISCLOSURE

In the electrical field, thermochromic pigment has been used to identify areas of overheating typically associated with electrical components (e.g., cables, wires, and wire terminations). Currently in the industry, thermochromic pigment is added to stickers, clips, and paint that are fixed or applied to electrical components. The stickers, clips and paint are then used to identify any overheating portions of the electrical components. However, each existing identification device/process is limited in its application and effectiveness. For example, thermochromic stickers have a tendency to fall off and/or not stick well to the electrical component depending on the environment where the electrical component is installed. Thermochromic clip diameter dimensions do not vary significantly and as a result are limited in their use to a select number of cables/wires. In addition, the heat-related indicators supplied by thermochromic stickers, clips, and paint is limited to the specific area where the thermochromic sticker, clips and paint are installed/applied to sense and identify areas of overheating. Due to the dimensional limitations of thermochromic devices, and associated limited area of use, it is possible that an overheating electrical component will go undetected.

Based on the foregoing, a need exists for a modular, secure, and reusable thermochromic device that detects electrical component overheating along a large extent of the exterior of an associated electrical component.

This background section is intended to introduce the reader to various aspects of art that may be related to various aspects of the present disclosure, which are described and/or claimed below. This discussion is believed to be helpful in providing the reader with supporting information to facilitate a better understanding of the various aspects of the present disclosure. Accordingly, it should be understood that these statements are to be read in this light, and not as admissions of prior art.

### SUMMARY OF THE DISCLOSURE

In one aspect, a thermochromic cable wrap is described. The thermochromic cable wrap includes a body defining a first surface and an opposite second surface, wherein the first surface defines an opening extending between a first end and an opposite second end. The body includes a thermochromic pigment configured to produce a change in color along at least a portion of the body in response to an increase in the temperature of the associated portion of the body.

In another aspect, a thermochromic cable wrap is described. The thermochromic cable wrap includes a body defining a first surface and an opposite second surface, wherein the first surface defines an opening extending between a first end and an opposite second end. The body includes a thermochromic pigment configured to produce an irreversible change in color along at least a portion of the body in response to an increase in the temperature of the associated portion of the body.

In yet another aspect, a method of use of a thermochromic cable wrap is described. The thermochromic cable wrap defines a first surface and an opposite second surface, wherein the first surface defines an opening extending between a first end and an opposite second end, the body including a thermochromic pigment configured to produce a change in color along at least a portion of the second surface in response to an increase in the temperature of the associated portion of the second surface. The method includes positioning the thermochromic cable wrap along an electronic component, such as a cable such that the first surface is in contact with the cable. The method includes producing the color change along a portion of the second surface of the thermochromic cable wrap in response to a temperature increase along the cable. The method includes displaying the color change along the second surface of the thermochromic cable wrap.

As used herein, “a”, “an”, and “the” refer to both singular and plural referents unless the context clearly dictates otherwise.

As used herein, the term “about” refers to a measurable value such as a parameter, an amount, a temporal duration, and the like and is meant to include variations of +/- 15% or less, preferably variations of +/- 10% or less, more preferably variations of +/- 5% or less, even more preferably variations of +/- 1% or less, and still more preferably variations of +/- 0.1% or less of and from the particularly recited value, in so far as such variations are appropriate to perform in the one or more embodiments of the disclosure described herein. Furthermore, it is also to be understood that the value to which the modifier “about” refers is itself specifically disclosed herein.

As used herein, spatially relative terms, such as “beneath”, “below”, “lower”, “above”, “upper”, “front”, “back”, “side”, “left”, “right”, “rear”, “top”, “bottom”, and the like, are used for ease of description to describe one element or feature’s relationship to another element(s) or feature(s). It is further understood that the terms “front”, “back”, “left”, and “right” are not intended to be limiting and are intended to be interchangeable, where appropriate. Further, it should be noted that the terms “first,” “second,” and the like herein do not denote any order, quantity, or relative importance, but rather are used to distinguish one element from another.

As used herein, the terms “comprise(s)”, “comprising”, and the like, specify the presence of stated features, integers, steps, operations, elements, and/or components, but do not preclude the presence or addition of one or more other features, integers, steps, operations, elements, components, and/or groups thereof.

As used herein, the terms “configure(s)”, “configuring”, and the like, refer to the capability of a component and/or assembly, but do not preclude the presence or addition of other capabilities, features, components, elements, operations, and any combinations thereof.

Chemical compounds are described using standard nomenclature. For example, any position not substituted by any indicated group is understood to have its valency filled by a bond as indicated, or a by hydrogen atom.

All ranges disclosed herein are inclusive of the endpoints, and the endpoints are independently combinable with each other. Each range disclosed herein constitutes a disclosure of any point or sub-range lying within the disclosed range.

All methods described herein can be performed in any suitable order unless otherwise indicated herein or otherwise clearly contradicted by context. The use of any and all examples, or exemplary language (e.g., “such as”), is intended merely to better illustrate the present disclosure and does not pose a limitation on the scope of the present disclosure or any embodiments unless otherwise claimed.

Any combination or permutation of features, functions and/or embodiments as disclosed herein is envisioned. Additional advantageous features, functions and applications of the disclosed systems, methods and assemblies of the present disclosure will be apparent from the description which follows, particularly when read in conjunction with the appended figures. All references listed in this disclosure are hereby incorporated by reference in their entireties.

### BRIEF DESCRIPTION OF THE DRAWINGS

Features and aspects of embodiments are described below with reference to the accompanying drawings, in which elements are not necessarily depicted to scale. Corresponding reference characters indicate corresponding parts throughout the several views of the drawings.

Exemplary embodiments of the present disclosure are further described with reference to the appended figures. It is to be noted that the various features, steps and combinations of features/steps described below and illustrated in the figures can be arranged and organized differently to result in embodiments which are still within the scope of the present disclosure.

To assist those of ordinary skill in the art in making and using the disclosed assemblies, systems and methods, reference is made to the appended figures, wherein:

FIG. 1 depicts a perspective view of a helical thermochromic cable wrap wrapped around a cable, as described herein;

FIG. 2 depicts a side view of the helical thermochromic cable wrap of FIG. 1;

FIG. 3 depicts an end view of the helical thermochromic cable wrap and the cable of FIG. 1;

FIG. 4 depicts a perspective view of a split loom thermochromic cable wrap wrapped around a cable, as described herein;

FIG. 5 depicts a side view of the split loom thermochromic cable wrap of FIG. 4;

FIG. 6 depicts an end view of the split loom thermochromic cable wrap and the cable of FIG. 4;

FIG. 7 depicts a perspective view of a partial thermochromic helical cable wrap wrapped around a cable;

FIG. 8 depicts a perspective view of a partial thermochromic split loom cable wrap wrapped around a cable;

FIG. 9A depicts a side view of a helical thermochromic cable wrap wrapped around a cable illustrating a color change location along the cable wrap;

FIG. 9B depicts a side view of a helical thermochromic cable wrap wrapped around a cable illustrating a color change location along the cable wrap; and

FIG. 9C depicts a side view of a partial split loom thermochromic cable wrap wrapped around a cable illustrating a color change location along the cable wrap.

### DETAILED DESCRIPTION OF THE DISCLOSURE

The exemplary embodiments disclosed herein describe an advantageous thermochromic cable wrap. The thermochromic cable wrap enables a user to quickly check for a temperature change, such as overheating, of wires, cables, electrical connectors, and combinations thereof. The thermochromic cable wrap includes an adjustable length to wrap around the desired length of cable. The thermochromic cable wrap is flexible to wrap around variously-sized cables, including a bundle of cables.

As the description proceeds, the term “color change” shall generally refer to the difference in visible color in a portion of the cable wrap that is undergoing a temperature change.

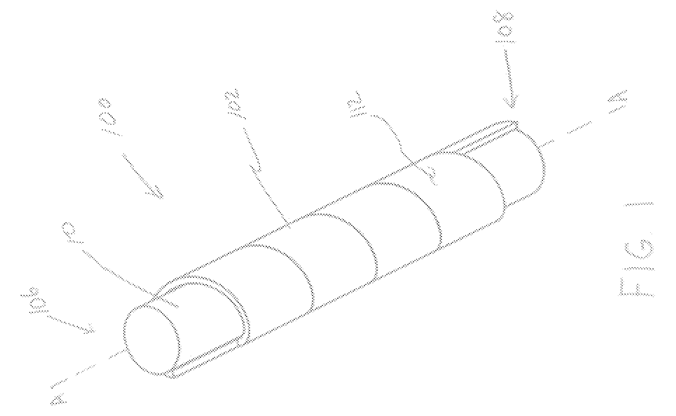

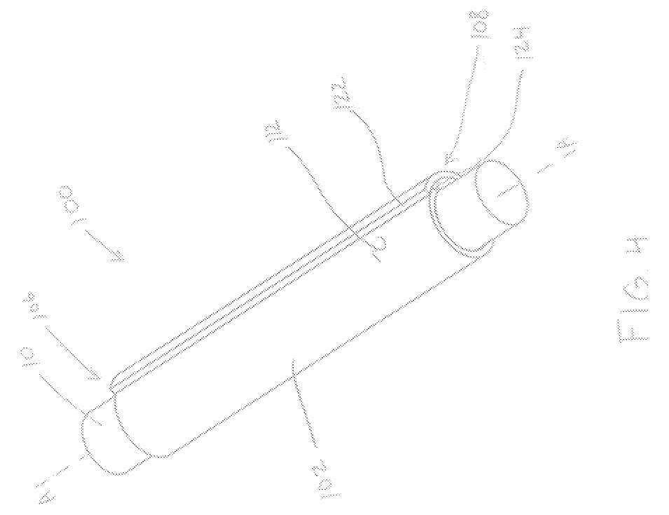

Referring to FIGS. 1 and 4, a thermochromic cable wrap 102 is wrapped at least partially around a cable 10, the assembly of which is identified as reference number 100. As the description proceeds, the terms “thermochromic cable wrap” and “cable wrap” may be used to identify wrap 102. The cable 10 may be any cable or wire that delivers electricity. As used herein, cables and wires may be used interchangeably, without departing from the spirit/scope of this disclosure. The cable 10 may also include an electrical connector (not shown). The cable wrap 102 may be wrapped at least partially around the cable 10, the electrical connector (not shown), or the cable 10 and the electrical connector (not shown). In some instances, the cable 10 may include two or more cables, commonly referred to as a bundle. In other embodiments, the wrap 102 may be applied, wrapped around other electrical components or other components and devices that may experience an undesirable temperature change that needs to be detected.

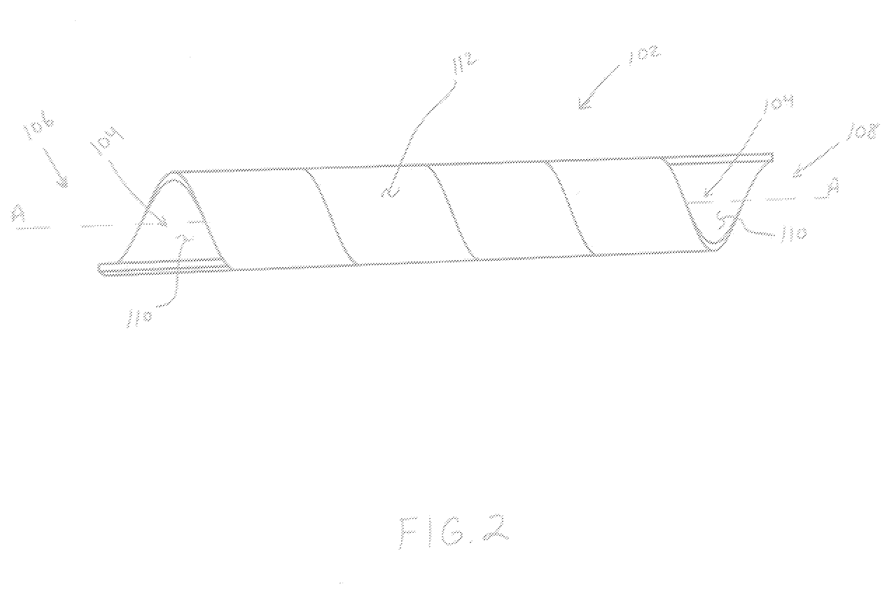

Referring to FIGS. 1-6, the thermochromic cable wrap 102 defines an opening 104 that extends between a first end 106 and a second end 108 and along a longitudinal axis A. The opening 104 is defined by at least an inner surface 110 of the cable wrap 102. The inner surface 110 extends between the first end 106 and the second end 108. The cable wrap 102 defines an outer surface 112 that is opposite from the inner surface 110. The inner surface 110 is positioned in closer proximity to the cable 10 than the outer surface 112.

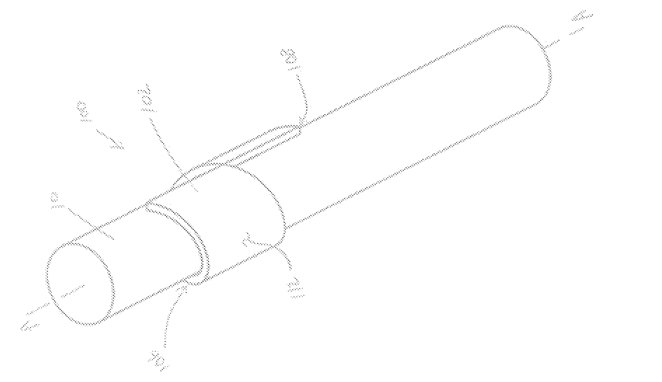

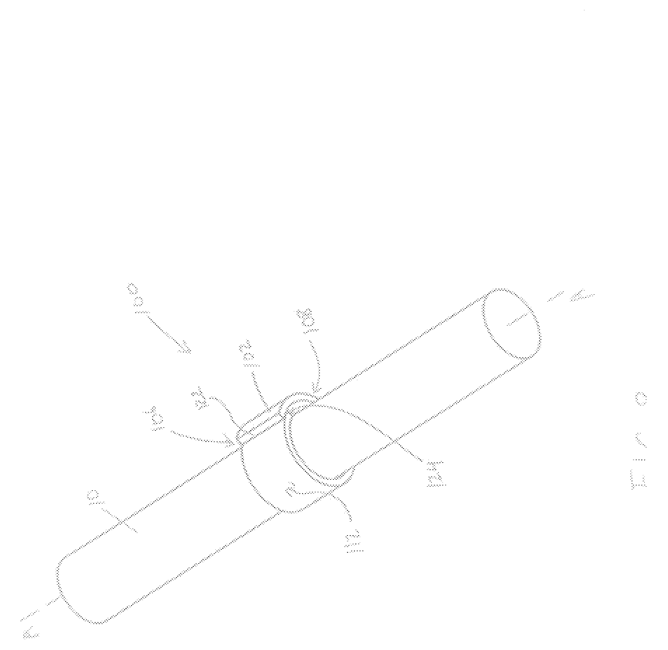

The first end 106 of the cable wrap 102 and the second end 108 of the cable wrap 102 may be shaped similar to each other or may be different. In some instances, the first end 106 and/or the second end 108 may define an end that has been cut from a reel/spool of the cable wrap 102. Thus, the length of the cable wrap 102 may be adjustable to fit a desired length. The length of the cable wrap may be made shorter or longer in length for a particular use. The cable wrap 102 may be continuously connected between the first end 106 to the second end 108. FIGS. 7 and 8 depict the cable wrap 102 having a shorter length than compared to FIGS. 1 and 4, respectively. Thus, the user of the cable wrap 102 may define a length that is sized based on a desired need and application. The length of the cable wrap 102 may extend the entirety of the length of the cable 10, as depicted in FIGS. 1 and 4, or may be sized to extend only a portion of the length of the cable 10, as depicted in FIGS. 7 and 8.

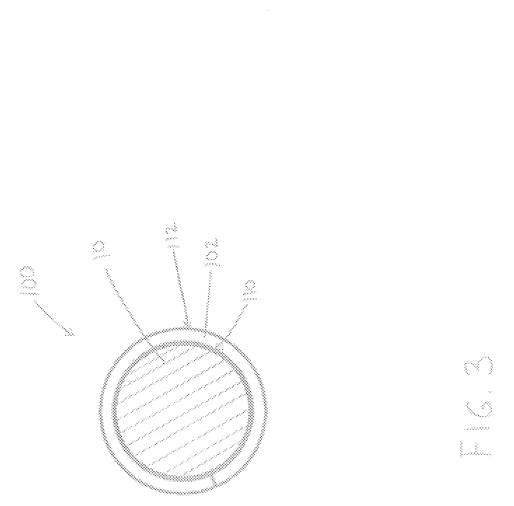

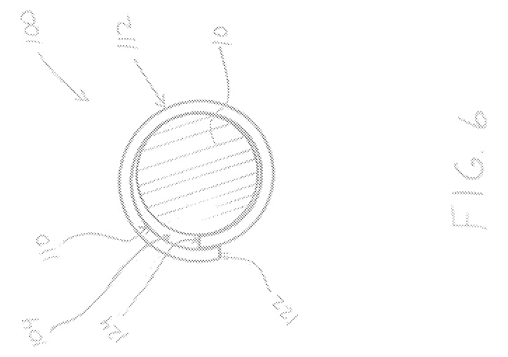

The cable wrap 102 may define an initial a cross-sectional shape that is a circle, oval, square, rectangle, triangle, diamond, and combinations and variations thereof. Referring to FIGS. 3 and 6, the cable wrap 102 may assume a cross-sectional shape that is a circle or an oval. However, the cable wrap 102 may assume a variety of cross-sectional shapes, including but not limited to, a square, rectangle, triangle, diamond, and combinations and variations thereof.

The cable wrap 102 may define a variety of trajectories that extend between the first end 106 and the second end 108 along the longitudinal axis A. In non-limiting examples, the cable wrap 102 may be helical, as depicted in FIGS. 1-3, split loom, as depicted in FIGS. 4-6, waves/ridges (not shown), woven/braided, ribbed, and combinations/variations thereof. In some instances, the cable wrap 102 may define one or more cutouts along the trajectory (“a cutout trajectory”) between the first end 106 and the second end 108. The cutouts may be shaped to resemble a triangle, circle, square, diamond, rectangle, half circle, and combinations and variations thereof. However, it should be understood that the cable wrap 102 described herein is not limited to a specific trajectory and alternate trajectories may be utilized without departing from the spirit/scope of this disclosure.

The cable wrap 102 may be at least partially coiled extending in a continuous helical configuration and arrangement from the first end 106 to the second end 108 along the longitudinal axis A. As depicted in FIGS. 1, 2, and 7, the cable wrap 102 may be helical extending in a continuous arrangement from the first end 106 to the second end 108. Between the ends 106, 108 the cable wrap 102 may be arranged in a helical configuration that passes around the cable in a generally clockwise or counterclockwise direction. In some instances, at least a portion of the cable wrap 102 may overlap another portion of the cable wrap 102. See FIGS. 4, 6 and 8. In other instances, at least a portion of the cable wrap 102 may be spaced away from another portion of the cable wrap 102. This spaced relationship may be created if the cable wrap 102 is pulled longitudinally and/or wrapped around a cable 10 having a greater diameter than the cable wrap 102.

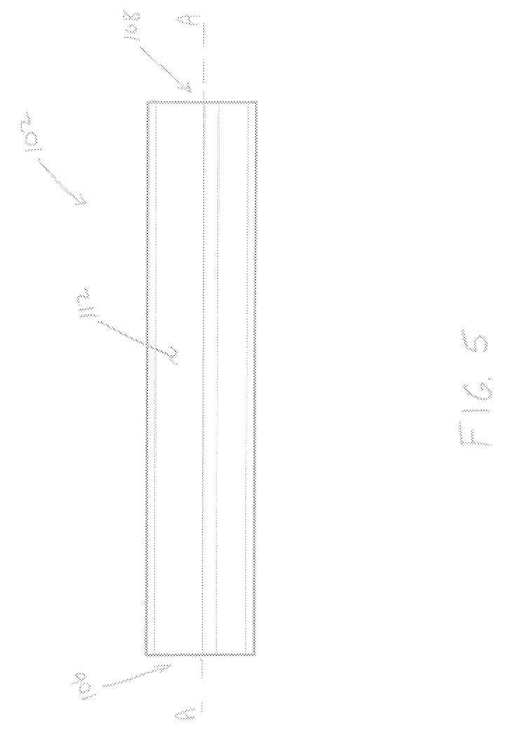

As an alternative to the helical configuration, the cable wrap 102 may be at wrapped around the cable 10 so that the free longitudinal edges of the wrap 122 and 124 extend longitudinally and are substantially parallel to longitudinal axis A-A. See FIGS. 4 and 5. The cable wrap longitudinal edges are substantially straight as they extend between the ends 106 and 108 and may terminate in abutment as shown in FIG. 3 or may overlap as shown in FIG. 6. As depicted in FIGS. 4, 5, and 8, the cable wrap 102 may be in a straight and continuous configuration from the first end 106 to the second end 108. In some instances, at least a portion of the cable wrap 102 may overlap another portion of the cable wrap 102. In other instances, at least a portion of the cable wrap 102 may be spaced away from another portion of the cable wrap 102. For example, if the cable wrap 102 is pulled longitudinally and/or wrapped around a cable 10 having a greater diameter than the cable wrap 102. It should be understood that the cable wrap 102 may be wrapped around the cable 10 and/or pulled over the cable 10 (e.g., a sleeve), without departing from the spirit/scope of this disclosure.

The cable wrap 102 may be flexible to expand or contract in the longitudinal direction between the first end 106 and the second end 108 and/or in the lateral direction relative to the cross-section of the opening. After the wrap is located around one or more cables, the flexibility and pliability of the cable wrap 102 enables the area of the opening formed at the ends of the cable wrap 102 to later be increased or decreased. As a result, the cable wrap is able to effectively accept one or more cables 10 that may, alone or in combination, have a diameter (or cross sectional area) that is greater than the initial diameter (or cross sectional area) of the cable wrap 102. For example, the cable wrap 102 may expand to wrap around one or more cables 10.

The cable wrap 102 may be manufactured from a plastic resin, for example, polyethylene. The cable wrap 102 is manufactured to include a thermochromic pigment that is added to the plastic resin during the manufacturing process. The thermochromic pigment may be dispersed throughout the cable wrap 102. In some instances, the thermochromic pigment may be limited to specific areas along the cable wrap 102. Incorporating the thermochromic pigment into the cable wrap 102 expands the capabilities of the cable wrap 102 to include an identification component, in addition to the traditional organizational use. Specifically, the cable wrap 102 including the thermochromic pigment may be used to identify overheating cables 10 and/or electrical connectors by displaying or otherwise providing a color change 114 along at least a portion of the outer surface 112 of the cable wrap 102 in the area where the temperature of the cable has increased to an increased level. The color change 114 may be a gradient color change or a solid color change. The gradient color change 114 may display a gradual change in color leading to a solid color or near solid color where the near solid color would be appear along the cable wrap 102 at a location where the cable experiencing the highest heating from cable 10. The areas surrounding that area are a color progression of the solid color. In a non-limiting example, the colors of the color change 114 may depict shades of a warm color (e.g., red, orange, yellow). The area with the highest heating may depict a solid or near solid warm color, for example, red as users often associate red with hot. It should be understood, however, that any color choice may be used to depict the color change 114.

The color change 114 may occur as the cable wrap 102 is exposed to an activation temperature. The activation temperature may vary based on the selected cable 10. For example, the activation temperature may be between about 45 degrees Fahrenheit (F) and about 170 degrees F. In a non-limiting example, the activation temperature of the cable wrap 102 may be between about 120 degrees F and about 160 degrees F. The color change 114 may be irreversible meaning that once the cable wrap 102 has developed the color change 114, the colors will remain visible, even if that portion of the cable wrap 102 is no longer experiencing overheating from the cable 10. The color change 114 may be reversible meaning that the color change 114 will be visible as long as the cable wrap 102 is exposed to at least the activation temperature. Once the cable wrap 102 is no longer exposed to the activation temperature, the color change 114 will at least partially disappear.

The cable wrap 102 may be reset to remove any color change 114, thereby making the cable wrap 102 reusable. The cable wrap 102 may be reset by exposing the cable wrap 102 to a resetting temperature for a period of time. The resetting temperature may be at least thirty-two (32) degrees F or below. In a non-limiting example, the resetting temperature may be at least five (5) degrees F or below. A cooling chamber (e.g., refrigerator, freezer, dry ice) may be used to expose the cable wrap 102 to the resetting temperature. The cable wrap 102 is exposed to the resetting temperature for at least thirty (30) minutes. In a non-limiting example, the cable wrap 102 is exposed to the resetting temperature for at least one (1) hour. In a non-limiting example, the cable wrap 102 is exposed to the resetting temperature of about five (5) degrees F for about one (1) hour. However, it should be understood that the temperature and duration are merely examples provided to enhance the discussion and are not intended to be limiting.

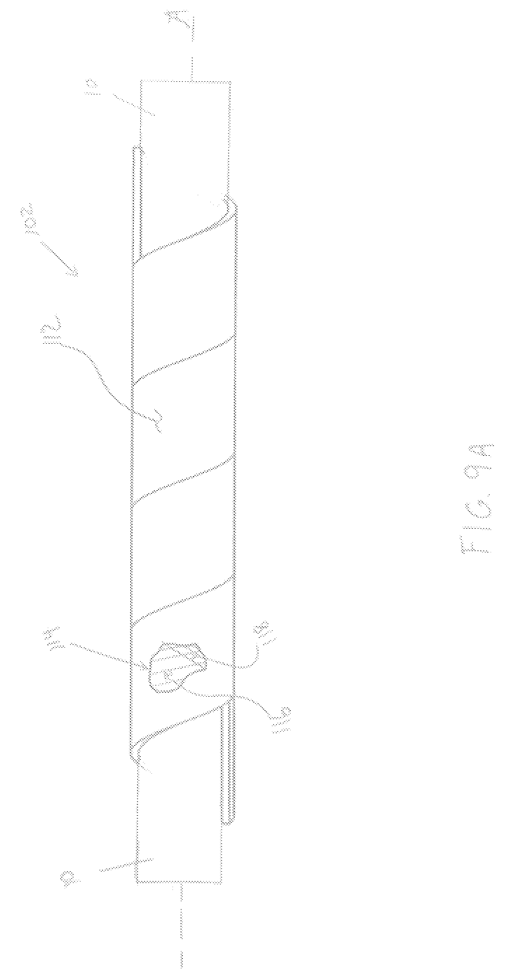

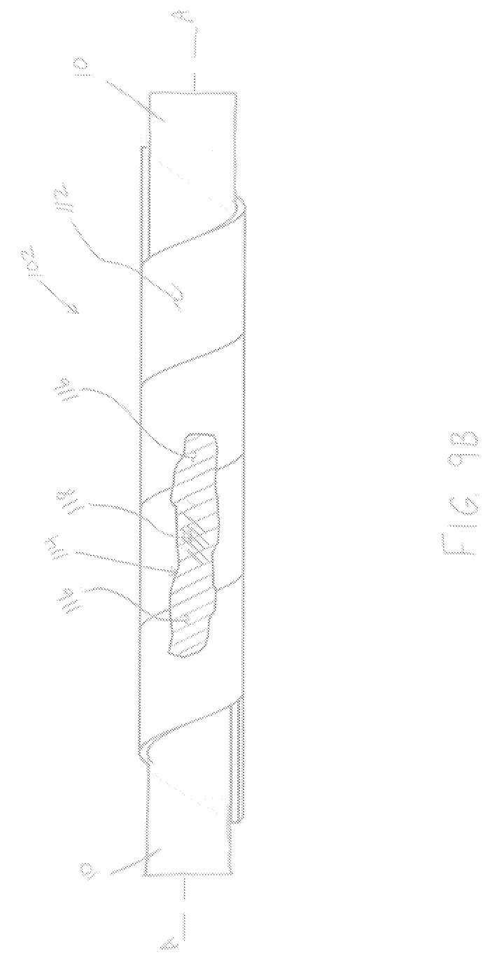

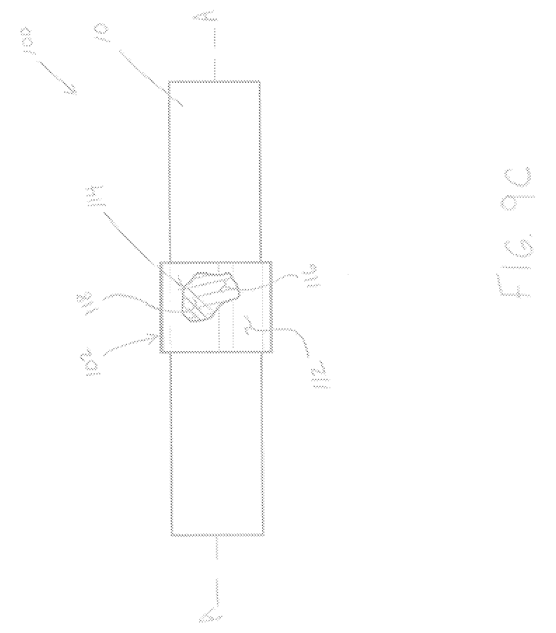

Referring to FIGS. 9A-9C, the cable wrap 102 is wrapped around at least a portion of the cable 10. The cable wrap 102 is exposed to an overheating of the cable 10 which produces the color change 114. The gradual change of the color change 114 is represented by reference numbers 116 and 118, where reference number 118 depicts a color that identifies a higher temperature than reference number 116. The higher temperature color change 118 may occur at or near the center of the color 114, as depicted in FIG. 9A or may occur at or near an edge of the color change 114, as depicted in FIGS. 9B and 9C. The location of the higher temperature color change 118 is not intended to be limiting but is intended to provide a more detailed explanation of use. In a non-limiting example, the higher temperature color change 118 may depict a red color and the reduced temperature color change 116 may depict a shade of red.

While the disclosure has been described with reference to preferred embodiments, it will be understood by those skilled in the art that various changes may be made, and equivalents may be substituted for the elements thereof without departing from the scope of the disclosure. In addition, many modifications may be made to adapt the teaching of the disclosure to particular use, application, manufacturing conditions, use conditions, composition, medium, size, and/or materials without departing from the essential scope and spirit of the disclosure. Therefore, it is intended that this disclosure is not limited to the exemplary embodiments and best mode contemplated for carrying out the embodiments of this disclosure as described herein. Since many modifications, variations, and changes in detail can be made to the described examples, it is intended that all matters in the preceding description and shown in the accompanying figures be interpreted as illustrative and not in a limiting sense.

1. A thermochromic cable wrap comprising:
a body defining a first surface and an opposite second surface, wherein the first surface defines an opening extending between a first end and an opposite second end,
the body comprising a thermochromic pigment configured to produce a change in color along at least a portion of the body in response to an increase in the temperature of the associated portion of the body.

2. The thermochromic cable wrap according to claim 1, wherein the body is configured to wrap around a cable, wherein the first surface of the body contacts the cable, wherein the color change is in response to the increase in the temperature increase at an area along the cable.

3. The thermochromic cable wrap according to claim 1, wherein the body defines a trajectory between the first end and the second end selected from the group consisting of a helical trajectory, a split loom trajectory, a wave trajectory, a woven/braided trajectory, a ribbed trajectory, a cutout trajectory, and combinations thereof.

4. The thermochromic cable wrap according to claim 1, wherein the body defines an initial cross-sectional shape that is selected from the group consisting of a circle, an oval, a square, a rectangle, a triangle, a diamond, and combinations thereof.

5. The thermochromic cable wrap according to claim 1, wherein the color change is a gradient color change.

6. The thermochromic cable wrap according to claim 1, wherein the color change is a solid color change.

7. The thermochromic cable wrap according to claim 1, wherein the length of the body measured from the first end to the second end is adjustable to a desired cable length.

8. The thermochromic cable wrap according to claim 2, wherein the body extends an entire length of the cable.

9. The thermochromic cable wrap according to claim 2, wherein the body wraps fully around the circumference of the cable.

10. The thermochromic cable wrap according to claim 2, wherein the body wraps around a plurality of cables.

11. The thermochromic cable wrap according to claim 1, wherein the temperature increase is above an activation temperature, wherein the activation temperature is between about 45 degrees F and about 170 degrees F.

12. The thermochromic cable wrap according to claim 1, wherein the body is manufactured from a plastic resin.

13. A thermochromic cable wrap comprising:
a body defining a first surface and an opposite second surface, wherein the first surface defines an opening extending between a first end and an opposite second end,
the body comprising a thermochromic pigment configured to produce an irreversible change in color along at least a portion of the body in response to an increase in the temperature of the associated portion of the body.

14. The thermochromic cable wrap according to claim 13, wherein the irreversible color change is resettable by exposing the body to a reduced temperature for a period of time.

15. The thermochromic cable wrap according to claim 14, wherein the reduced temperature is at least 32 degrees F.

16. The thermochromic cable wrap according to claim 14, wherein the period of time is at least thirty minutes.

17. A method of use of a thermochromic cable wrap, wherein the thermochromic cable wrap defines a first surface and an opposite second surface, wherein the first surface defines an opening extending between a first end and an opposite second end, the body comprising a thermochromic pigment configured to produce a change in color along at least a portion of the second surface in response to an increase in the temperature of the associated portion of the second surface, the method comprising:
positioning the thermochromic cable wrap along an electronic component, such as a cable such that the first surface is in contact with the cable;
producing the color change along a portion of the second surface of the thermochromic cable wrap in response to the increase in the temperature at a position along the cable;
displaying the color change along the second surface of the thermochromic cable wrap.

18. The method according to claim 17, wherein the color change is in response to the increase in the temperature above an activation temperature, wherein the activation temperature is between about 45 degrees F to about 170 degrees F.

19. The method according to claim 17, wherein the thermochromic cable wrap is resettable after the color change by exposing the body to a reduced temperature for a period of time.

20. The method according to claim 17, wherein the color change of the thermochromic cable wrap is irreversible.
